(19) United States
(12) Patent Application Publication
(10) Pub. No.: US 2008/0163720 A1
(43) Pub. Date: Jul. 10, 2008

(54) Steering Wheel for a Motor Vehicle

(75) Inventor: Dieter Markfort, Berlin (DE)

Correspondence Address: FITCH EVEN TABIN AND FLANNERY, 120 SOUTH LA SALLE STREET, SUITE 1600, CHICAGO, IL, 60603-3406, US

(73) Assignee: TAKATA-PETRI AG, Aschaffenbug (DE)

(21) Appl. No.: 11/911,096

(22) PCT Filed: Feb. 9, 2006
(86) PCT No.: PCT/DE06/00219

§ 371 Date: Mar. 5, 2008

(30) Foreign Application Priority Data
Apr. 8, 2005 (DE) 10 2005 017 076.5

(51) Int. Cl. B62D 1/04

(52) U.S. Cl. 74/552

(57) ABSTRACT

A steering wheel for a motor vehicle is disclosed, which can be mounted to rotate about a steering axle (D). The wheel includes a steering-wheel rim for actuating the steering wheel. The rim extends in a peripheral direction that runs around the steering axle (D) in the peripheral direction and has a cross-section that alters in the peripheral direction. According to one form, to alter the cross-section at least along one part of the steering-wheel rim, the spatial orientation of a predetermined cross-sectional contour varies in the peripheral direction in relation to the steering axle (D).

The invention relates to a steering wheel for a motor vehicle according to the preamble of claim 1.

Such a steering wheel may be rotatably mounted on the motor vehicle about a steering axis and comprises a steering wheel rim as an essential element for actuating the steering wheel, which extends in a peripheral direction surrounding the steering axis and has a cross section oriented perpendicular to the peripheral direction.

It is known that with such steering wheels, the cross section of the steering wheel rim alters in the peripheral direction of the steering wheel rim, see DE 1010393. In this connection, the steering wheel rim has portions in its peripheral direction, of which the cross-sectional surfaces are larger and/or smaller in comparison with the portions of the steering wheel rim adjacent to the cross-sectional surfaces.

The object of the invention is to provide a steering wheel of the aforementioned type with improved handleability.

This object is achieved by a steering wheel for a motor vehicle with the features of claim 1.

Accordingly, it is provided that for altering the cross section at least along a part of the steering wheel rim, the spatial orientation of a predetermined cross-sectional contour varies in the peripheral direction relative to the steering axis. An edge of the cross section is understood in this case by “cross-sectional contour”.

As a result, the shape of the steering wheel rim may be easily altered in a peripheral direction of the steering wheel rim, such that the steering wheel rim is adapted to a natural grip of the hands of a driver in any grip position.

The cross section of a steering wheel rim may generally be altered along the steering wheel rim, i.e. perpendicular to the peripheral direction thereof, by its shape or its orientation being spatially altered. This is tantamount to an alteration of the cross-sectional contour itself and/or a spatial alteration to the orientation of the cross-sectional contour, when the shape of the cross-sectional contour is itself uniform, i.e. unaltered. Preferably, the alteration of the orientation of the cross-sectional contour of the steering wheel rim may be carried out continuously in the peripheral direction of the steering wheel rim. That the cross section and/or the cross-sectional contour is oriented spatially, presupposes that the cross-sectional contour has no continuous rotational symmetry relative to the peripheral direction of the steering wheel rim. It is naturally also possible for the shape and orientation of a cross-sectional contour to be altered at the same time. Additionally, the surface of a cross section with an otherwise uniform shape of the associated cross-sectional contour may be altered (scaling of the cross section).

Preferably, the spatial orientation of the cross-sectional contour of the steering wheel rim is only altered along one part of the steering wheel rim. Such a part of the steering wheel rim may, for example, be an upper half of an intrinsically closed steering wheel rim—relative to a straight-ahead driving position of the steering wheel.

In a further variant of the invention, the spatial orientation of the cross-sectional contour is altered along the entire steering wheel rim, regions of the steering wheel rim being able to be removed, at which spokes of the steering wheel, which are used to connect a hub of the steering wheel to the steering wheel rim, merge with the steering wheel rim.

In a preferred variant of the invention, the spatial orientation of the cross-sectional contour is altered when the cross-sectional contour is uniform in the peripheral direction of the steering wheel rim, the cross-sectional contour being preferably configured as an elongate, enclosed contour with a longitudinal axis, for example as an oval or an ellipse. The spatial position of the longitudinal axis, therefore, defines the spatial orientation of the cross-sectional contour. Furthermore, the orientation of the cross-sectional contour varies in the peripheral direction of the steering wheel rim, preferably when the surface of the cross section is uniform.

Preferably, the longitudinal axis of the elongate cross-sectional contour, with a steering wheel in a straight-ahead driving position—relative to when the steering wheel is installed in a motor vehicle—encloses a first angle with the steering axis. The size of the first angle depends, therefore, on the position of the cross section of the steering wheel rim, in the peripheral direction of the steering wheel rim, and namely such that it increases from an uppermost region of the steering wheel rim (relative to the vertical vehicle axis) in the peripheral direction of the steering wheel rim, until it reaches a maximum value—approximately half way between the uppermost and a lowermost region (relative to the vertical vehicle axis).

Preferably, the first angle decreases from its maximum value which it reaches approximately half way between the uppermost and the lowermost region of the steering wheel rim, in the peripheral direction towards the lowermost region of the steering wheel rim.

Advantageously, the steering wheel rim at its uppermost region has an elongate cross-sectional contour of which the longitudinal axis encloses a first angle of 0° with the steering axis, i.e. the longitudinal axis extends parallel to the steering axis. As a result, there is less obstruction to the view of the driver by the steering wheel rim, as the longitudinal axis of the cross-sectional contour extends substantially in the direction of the view of the driver straight-ahead, so that in the direction of the view of the driver straight-ahead, only one narrow upper face of the upper region of the steering wheel rim extending transversely to the longitudinal axis faces said driver.

The steering wheel rim also preferably comprises at its lowermost region an elongate cross-sectional contour, of which the longitudinal axis also encloses a first angle of 0° with the steering axis. The lowermost region, therefore, forms a comfortable support surface for the hands of a driver.

In a further preferred embodiment of the invention, the steering wheel rim, in a straight-ahead driving position of the steering wheel rim—relative to when the steering wheel is installed in a steering wheel—half way between the uppermost and the lowermost region of the steering wheel rim, has a cross-sectional contour of which the longitudinal axis encloses a first angle of 45° with the steering axis. This is advantageous, as the steering wheel rim is particularly frequently gripped in the region of the projecting cross-sectional contour when steering the motor vehicle (on both sides of the steering axis of the steering wheel along the vehicle transverse axis), a natural grip position of the hands of a driver being possible, due to the first angle of 45°, in which the wrist does not have to be excessively bent. Additionally, the elongate cross-sectional contour in this region of the steering wheel rim corresponds approximately to that contour which the thumb and forefinger of a driver form with a relaxed grip of one hand.

Preferably, the steering wheel rim surrounds the steering axis in a manner which is intrinsically closed. Additionally, the outer contour of the steering wheel rim is preferably at a distance from the steering axis in a direction perpendicular to the steering axis, which—relative to a straight-ahead driving position of the steering wheel when installed in a motor vehicle—along the vertical vehicle axis, is greater above the steering axis than below the steering axis. Preferably, the distance between the outer contour of the steering wheel rim and the steering axis as well as the radius of the outer contour is approximately uniform in a direction perpendicular to the steering axis in a region which, from the view of a driver, extends along the intrinsically closed steering wheel rim clockwise from the 8 o'clock position to the 4 o'clock position. This region on both sides of the steering axis merges with a flattened portion of the steering wheel rim extending parallel to the vehicle transverse axis at a smaller distance from the steering axis. In this manner, the movement space for the driver of a motor vehicle may be advantageously increased below the steering wheel rim (relative to the vertical vehicle axis). Additionally, such a flattened steering wheel rim provides the steering wheel with a particularly sporty appearance.

In a further variant of the invention, a portion of the steering wheel rim extending in the peripheral direction is provided with a cross section oriented perpendicularly to the peripheral direction, which has an elongate, enclosed cross-sectional contour with a longitudinal axis, which encloses a first angle with the steering axis.

Preferably, the portion is configured to be adjustable, such that the first angle is variable. To this end, the portion of the steering wheel rim is configured to be preferably manually adjustable. Such a portion of a steering wheel rim may for example be portions of the steering wheel rim which—relative to a straight-ahead driving position of the steering wheel when the steering wheel is installed in a motor vehicle—are arranged on both sides (along the vehicle transverse axis) of a hub body of the steering wheel. In the peripheral direction, such adjustable portions have at least the width of one hand of a driver.

Preferably, such a portion of the steering wheel rim is configured to be manually adjustable at least between a first and a second position, with respectively different values of the first angle. In the two positions, the variable portion may be respectively releasably engaged, so that it may not be inadvertently adjusted during the journey.

Alternatively or additionally to a manual adjustability, the adjustable portion is preferably designed and provided to adjust the first angle electrically and/or to be moved hydraulically. Actuating elements for actuating such an automatic adjustment may be provided directly on the steering wheel rim, so that a driver does not have to take the hands off the steering wheel to adjust such a portion of the steering wheel rim.

In a variant of the invention, it is provided that the adjustable portion of the steering wheel rim is removably secured to the steering wheel. In this connection, the portion of the steering wheel rim may be shell elements, which may be releasably secured to a steering wheel rim structure as a base body of the steering wheel rim and, when secured, form part of a steering wheel cover surrounding the steering wheel structure. Advantageously, therefore, easy removability of the adjustable portion is firstly ensured during servicing, secondly the removability allows the steering wheel to be individually adapted to customer requirements with regard to the design of the steering wheel. It is naturally also possible to provide such removable portions of the steering wheel rim without an adjustment function.

Preferably, the steering wheel comprises a hub body via which the steering wheel may be mounted rotatably about the steering axis on a motor vehicle. A first spoke is provided for connecting the steering wheel rim to the hub body. Said spoke is preferably configured to extend longitudinally in a longitudinal extension direction, the longitudinal extension direction of the first spoke being oriented in a straight-ahead driving position of the steering wheel—relative to when the steering wheel is installed in a motor vehicle—substantially parallel to the vehicle transverse axis.

In a variant of the invention, in a region adjacent to the hub body, the first spoke provides a cross section oriented perpendicularly to its longitudinal extension direction, which preferably has a circular cross-sectional contour.

Furthermore, the first spoke is preferably used as a support for an actuating lever for activating and/or controlling a component of a motor vehicle. Preferably, the actuating lever projects from the first spoke transversely to the longitudinal extension direction of the first spoke and is pivotably mounted on the first spoke about this longitudinal extension direction for activating and/or controlling a component of a motor vehicle. Such actuating levers may, for example, be used to change the gear ratios during driving.

Preferably, the first spoke comprises in a first region adjacent to the steering wheel rim a cross section oriented perpendicularly to its longitudinal extension direction, with an elongate, enclosed cross-sectional contour which has a longitudinal axis which forms a second angle with an axis extending parallel to the steering axis, which is less than 45°. Preferably, the second angle is 22.5°. As a result, the longitudinal axis of the cross-sectional contour—relative to when the steering wheel is installed in a motor vehicle—extends substantially parallel to the longitudinal axis of the vehicle, i.e. horizontally, taking as a basis conventional angles of inclination of the steering axis relative to the longitudinal axis of the vehicle. Due to the cross-sectional contour of flat configuration of the first spoke in the first region adjacent to the steering wheel rim, it may be used there, in particular, as a support surface for a hand or an area of a hand of a driver, for example a thumb. Preferably, a depression adapted to the shape of the thumb is configured on such a support surface for a thumb.

Preferably, the steering wheel according to the invention comprises a further first spoke, which is configured in a mirror inverted manner to the first spoke on the steering wheel. In this connection, with a steering wheel in the straight-ahead driving position—relative to when the steering wheel is installed in a motor vehicle—the plane of symmetry is stretched through the steering axis and a vertical vehicle axis intersecting the steering axis and extending parallel to the vertical vehicle axis.

In a further variant of the invention, a second spoke is provided which extends longitudinally in a longitudinal extension direction and connects the steering wheel rim to the hub body of the steering wheel. Preferably, the second spoke, in a region adjacent to the hub body, has a cross section with a circular cross-sectional contour oriented perpendicularly to its longitudinal extension direction. Preferably, on the second spoke of the steering wheel a rotary selector switch for activating and controlling safety and/or comfort functions of motor vehicle equipment is rotatably mounted about the longitudinal extension direction of the second spoke.

Preferably, the rotary selector switch has an actuating surface surrounding the second spoke transversely to its longitudinal extension direction for actuating the rotary selector switch, which merges steplessly with an outer surface of the second spoke, preferably in the longitudinal extension direction of the second spoke. As a result, one hand of a driver is able to slide along the second spoke without being hindered by an actuating element projecting from the surface of the second spoke.

Preferably, in a second region of the second spoke adjacent to the steering wheel rim (and/or of the steering wheel rim) a cross section of the second spoke oriented perpendicularly to the longitudinal extension direction of the second spoke is provided, with an elongate, enclosed cross-sectional contour which has a longitudinal axis, which forms a third angle with an axis extending parallel to the steering axis, which is preferably acute and is, in particular, 45°.

In one embodiment of the invention it is provided that the first spoke—relative to when the steering wheel is installed in a motor vehicle—in a straight-ahead driving position of the steering wheel along the vertical vehicle axis, is arranged above the second spoke, preferably the first and the second spoke diverging from one another away from the hub body in the direction of the steering wheel rim.

Preferably, the steering wheel according to the invention has a further second spoke which is configured in a mirror inverted manner to the second spoke on the steering wheel, relative to the plane of symmetry of the steering wheel.

Furthermore, a third spoke is preferably provided which is also used for connecting the hub body to the steering wheel rim and—relative to when the steering wheel is installed in a motor vehicle—with a straight-ahead driving position of the steering wheel, extends along the plane of symmetry of the steering wheel. This third spoke is preferably used as a support for functional units of the steering wheel which are portable, i.e. releasably secured to the steering wheel, such as for example a storage means for storing motor vehicle-related data and passenger-related data. In this connection, the storage means—relative to when the steering wheel is installed in a motor vehicle—may be secured to an upper face of the steering wheel rim facing a driver. Preferably, the storage means has a functional interface which, when the storage means is secured to the steering wheel, faces a driver. This functional interface is preferably provided and designed to detect biometric features of a driver, for example a fingerprint or an iris of a driver.

Furthermore, the storage means may be activated by identifying a fingerprint of a driver, and a motor vehicle may be started by identifying a fingerprint of a driver by means of the storage means. Also, the storage means may comprise operating elements with which safety and comfort functions of motor vehicle equipment may be activated and controlled. For remote unlocking of a door of the motor vehicle, the storage means may comprise, for example, a transmission means. The storage means is a read-only memory, preferably in the form of a USB memory stick which is able to exchange data relating to the motor vehicle and passengers with the motor vehicle via an interface (USB) arranged on the third spoke as a component of the steering wheel. Such data may include a selection of the following data:
vehicle access codes,
settings for comfort function parameters,
settings for safety function parameters,
personal driving profile,
travel route information,
appointments
vehicle data.

Furthermore, the steering wheel rim may comprise display means for displaying such data which, preferably with a straight-ahead driving position of the steering wheel rim—relative to when the steering wheel is installed in a motor vehicle—are integrated into an upper face of an upper half of the steering wheel rim facing the driver. The steering wheel may further comprise a switch element which is used for setting a position of the steering column, i.e. the course of the steering axis relative to the longitudinal axis of the vehicle and/or vertical vehicle axis.

Further features and advantages of the invention are described by figures of embodiments with reference to the following description of the figures, in which:

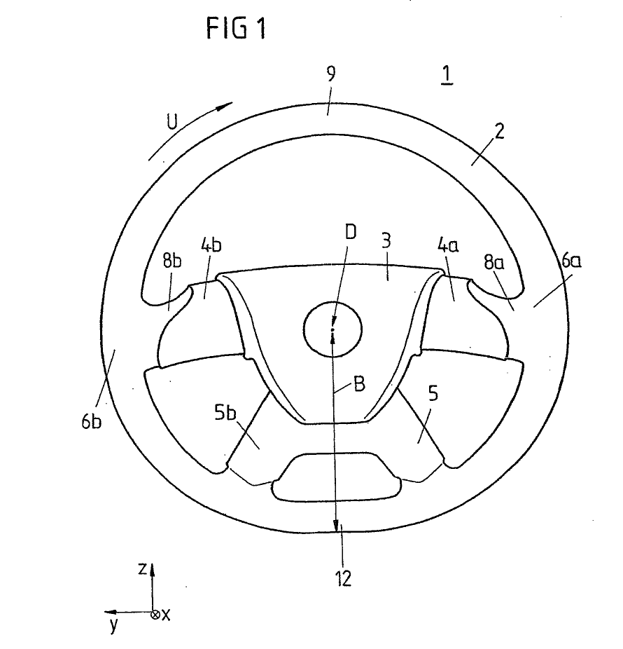

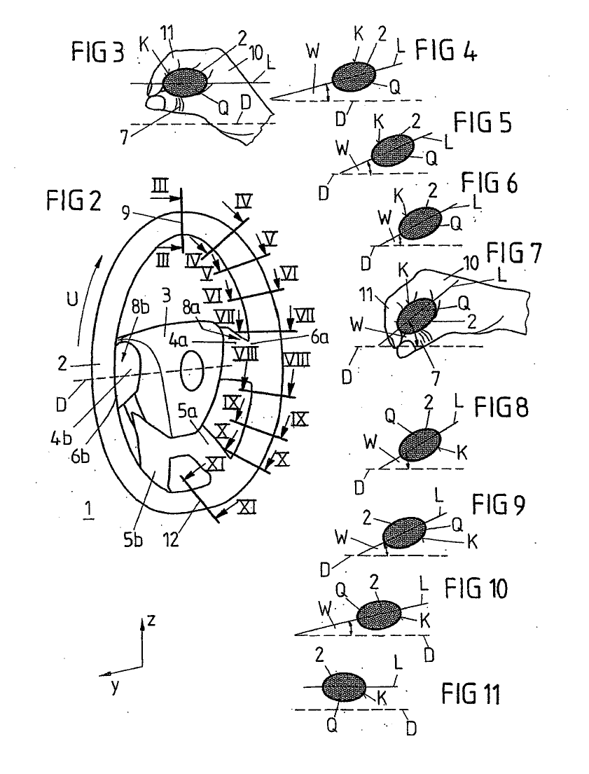

FIG. 1 shows a plan view of a steering wheel according to the invention,

FIG. 2 shows a perspective view of the steering wheel shown in FIG. 1,

FIGS. 3-11 show respectively a section through a steering wheel rim of the steering wheel shown in FIG. 2 along the lines III-III to XI-XI,

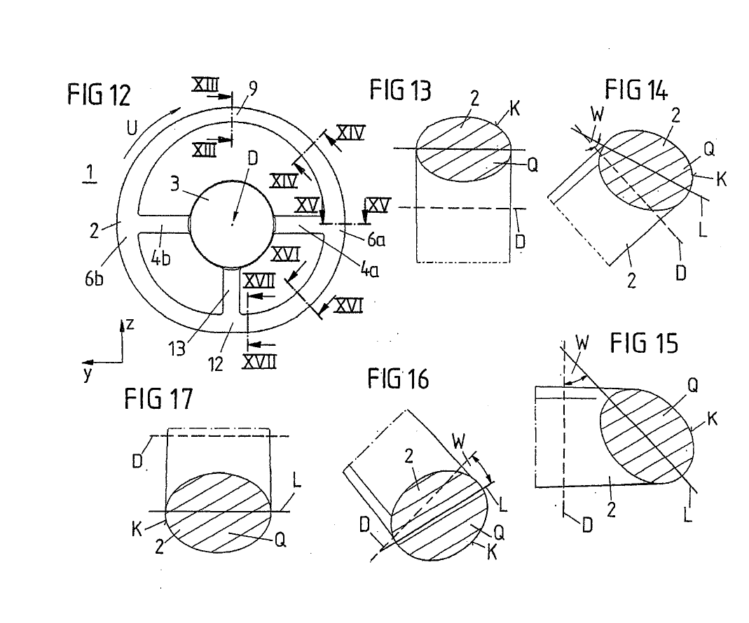

FIG. 12 shows a modification of the steering wheel shown in FIG. 1,

FIGS. 13-17 show respectively a section through a steering wheel rim of the steering wheel shown in FIG. 12 along the lines XIII-XIII to XVII-XVII,

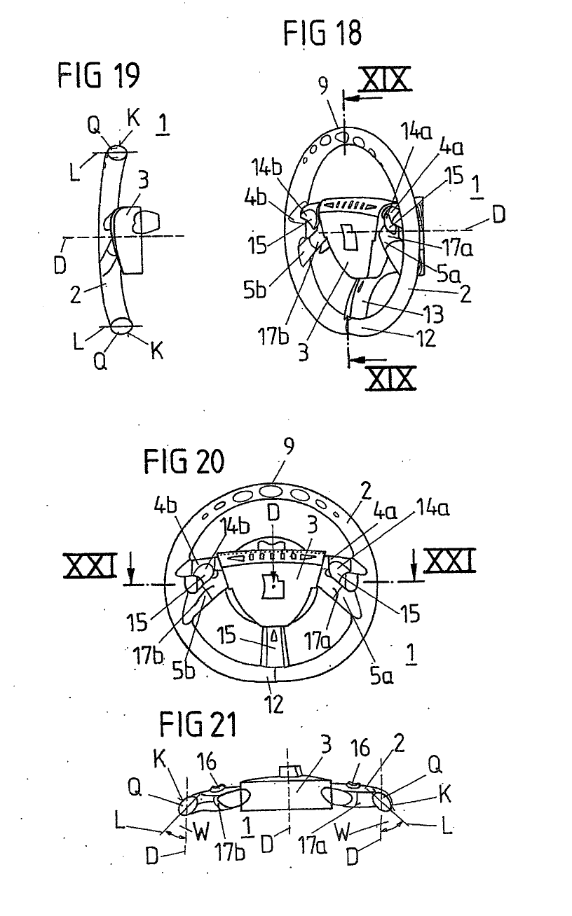

FIG. 18 shows a perspective view of a further modification of the steering wheel shown in FIGS. 1 and/or 12,

FIG. 19 shows a section through the steering wheel shown in FIG. 18 along the line XIX-XIX,

FIG. 20 shows a plan view of the steering wheel shown in FIGS. 18 and/or 19,

FIG. 21 shows a section through the steering wheel shown in FIG. 20 along the line XXI-XXI,

FIG. 22 shows a plan view of a steering wheel of the type shown in FIG. 12 with a portion of a steering wheel cover of the steering wheel rim removed from a steering wheel rim structure of the steering wheel,

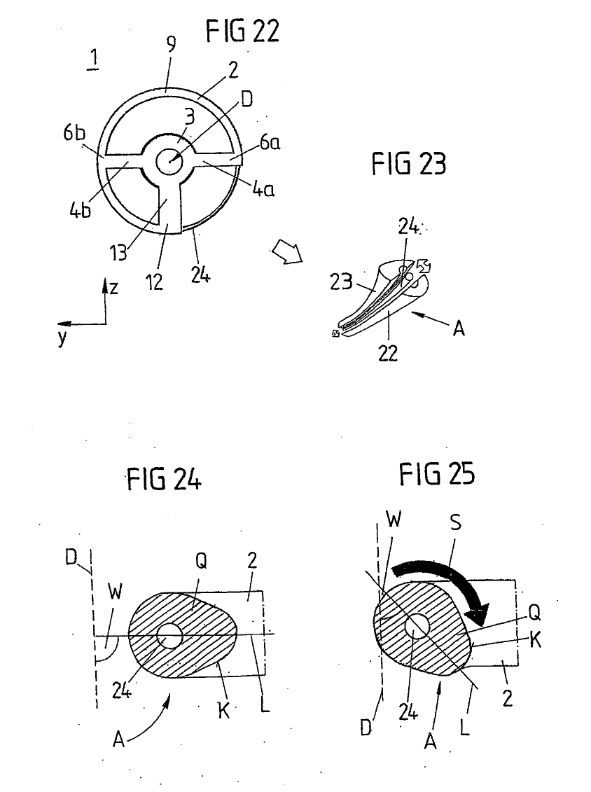

FIG. 23 shows an exploded view of part of the steering wheel rim structure shown in FIG. 22, with a removable portion of the steering wheel cover of the steering wheel rim in the form of two shell elements,

FIG. 24 shows an adjustable portion of a steering wheel rim of a steering wheel according to the invention in a first position,

FIG. 25 shows the portion shown in FIG. 24 after an adjusting movement into a second position which is different from the first position,

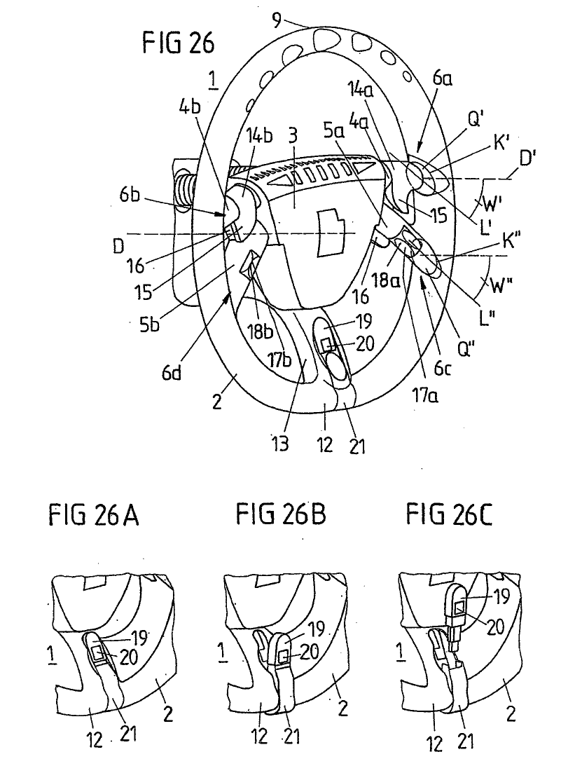

FIG. 26 shows a perspective view of a steering wheel of the type shown in FIG. 18 with a storage means secured to a spoke of the steering wheel,

FIG. 26A shows an enlarged view of the storage means of FIG. 26 secured to the spoke,

FIG. 26B shows the storage means of FIG. 26A folded out from the spoke, and

FIG. 26C shows the storage means of FIGS. 26A and/or 26B withdrawn from the spoke.

FIG. 1 shows, in connection with FIGS. 2 to 11, a plan view of a steering wheel 1 with an intrinsically closed steering wheel rim 2, which extends in a peripheral direction U which surrounds a steering axis D of the steering wheel 1, about which the steering wheel 1 is rotatably mounted on a motor vehicle, transversely to the steering axis D. Such a steering wheel rim 2 may comprise a steering wheel rim structure 24 as a base body (see FIG. 22) which is surrounded by a steering wheel cover. Generally, said steering wheel cover consists of foam and may have a cladding as an outermost layer, which for example may consist of leather. The steering axis D is perpendicular to the paper plane in FIG. 1. The following is always to be based on the fact that the steering wheel 1 is in a straight-ahead driving position and, namely, relative to when the steering wheel 1 is installed in a motor vehicle, the peripheral direction U surrounding the steering axis D in a clockwise direction from the view of a driver.

The rotatable mounting of the steering wheel 1 on a motor vehicle is carried out via a hub body 3 surrounded by the steering wheel rim 2, and which is connected to the steering wheel rim 2 via two first spokes 4a, 4b and via two second spokes 5a, 5b. The two first spokes 4a, 4b are respectively configured to extend longitudinally in a longitudinal extension direction and project from the hub body 3 such that their longitudinal extension directions extend substantially parallel to the vehicle transverse axis y. In this connection, the two first spokes 4a, 4b divide the steering wheel rim 2 along the vertical vehicle axis z approximately into an upper half and a lower half.

It is possible that the centre of gravity of the hub body 3 is arranged along the steering axis D, viewed from a driver, behind an extension plane, in which the steering wheel rim 2 surrounds the steering axis D. In this case, the two first spokes 4a, 4b can enclose an acute angle with the vehicle transverse axis y.

Relative to the vertical vehicle axis z, the two second spokes 5a, 5b which are also configured to extend longitudinally, respectively in a longitudinal extension direction, below the two first spokes 4a, 4b project from the hub body 3 and extend therefrom to the lower half of the steering wheel rim 2, and namely such that they diverge from one another away from the hub body 3 in the direction of the lower half of the steering wheel rim 2. Both the two first spokes 4a, 4b and the two second spokes 5a, 5b are respectively constructed mirror symmetrically to one another relative to a plane of mirror symmetry of the steering wheel 1, which is stretched through the steering axis D and the vertical vehicle axis z.

The steering wheel rim 2 of the steering wheel 1 is configured to be flattened along the vertical vehicle axis z, i.e. in a direction perpendicular to the steering axis D the steering wheel rim 2 is at a distance B which, along the vertical vehicle axis z below the steering axis D, i.e. in the lower half of the steering wheel rim 2, is shorter than in the upper half thereof.

Frequently, a driver grips the steering wheel rim 2, when guiding with the hands along the vehicle transverse axis y, on both sides of the hub body 3, i.e. at first regions 6a, 6b of the steering wheel rim 2, at which the first spokes 4a, 4b run into the steering wheel rim 2 on an inner face of the steering wheel rim 2 facing the hub body 3. In this connection, the right and/or the left thumb 7 of a driver (from the view of a driver), respectively rest on the inner face of the steering wheel rim 2 and on one support surface 8a of the first spoke 4a facing the roof of the motor vehicle and/or a further support surface 8b of the further first spoke 4b, which is respectively configured in the form of a depression which is adapted to the shape of a thumb 7 bent for gripping.

The steering wheel rim 2 of the steering wheel 1 comprises, perpendicular to its peripheral direction U, an elongate cross section Q with an enclosed cross-sectional contour K in the form of an oval. The cross-sectional contour K accordingly has a spatial orientation which is defined by the spatial orientation of a longitudinal axis L of the cross-sectional contour K which bisects the cross section Q in its longitudinal direction of expansion. In the peripheral direction U of the steering wheel rim 2, the cross-sectional contour K preferably has a uniform shape and the cross section Q bounded by the cross-sectional contour K preferably has a uniform surface. The cross-sectional surface of the cross section Q may, however, also be increased and/or reduced in the peripheral direction U of the steering wheel rim 2 when the cross-sectional contour K is otherwise uniform. Smaller alterations to the shape of the cross-sectional contour K are also possible in the peripheral direction U, for example due to different coatings of the steering wheel rim 2 (also including decoration in the form of decor elements, etc.) or due to functional elements integrated in the steering wheel rim 2, such as for example visual displays or actuating elements for controlling motor vehicle components. Furthermore, the shape of the cross section Q of the steering wheel rim alters at those regions of the steering wheel rim 2 at which the spokes 4a, 4b, 5a and 5b of the steering wheel 1 are secured to the steering wheel rim 2.

FIGS. 3 to 11 respectively show a section through the steering wheel rim 2 and namely along the lines III-III to XI-XI of FIG. 2, which shows the steering wheel 1 shown in FIG. 1 in a perspective view. Accordingly, the cross section Q at an uppermost region 9 of the steering wheel rim 2 along the vertical vehicle axis z has a cross-sectional contour K, of which the longitudinal axis L according to FIG. 3 encloses a first angle W of 0° with the steering axis D (dotted line) of the steering wheel 1, i.e. the longitudinal axis L of the cross-sectional contour K extends parallel to the steering axis D. In this connection, it is noteworthy that the steering axis D shown in FIGS. 3 to 11 respectively by a dotted line, for reasons of improved clarity, is respectively displaced parallel to the steering wheel rim 2.

In the further course of the steering wheel rim 2 in the peripheral direction U, the first angle W increases monotonically clockwise (from the view of a driver) and reaches its maximum value of 45° along the vertical vehicle axis z just above the first region 6a of the steering wheel rim 2 at which the first spoke 4a merges with the steering wheel rim 2.

The maximum first angle W of 45° allows a driver to grip the steering wheel rim 2 at the first region 6a, such that the corresponding wrist of one hand 10 of the driver according to FIG. 7 relative to a lower arm (not shown fully in FIG. 7) of the driver does not have to be bent, and therefore allows a relaxed grip of the hand 10 of the driver. The longitudinal extension of the cross-sectional contour K along its longitudinal axis L allows, therefore, a relaxed grip of the steering wheel rim 2 with a large-surface contact region between the hand 10 of the driver and the steering wheel rim 2. This is because the thumb 7 and forefinger 11 of one hand 10 describe an elongate oval contour, with a relaxed grip of the hand 10.

Based on its maximum value of 45°, just above the first spoke 4a, the first angle W decreases between the longitudinal axis L of the cross-sectional contour K and the steering axis D of the steering wheel 1 in the peripheral direction U, until at a lowermost region 12 of the steering wheel rim 2—relative to the vertical vehicle axis z—it is again 0°.

The plane of symmetry stretched through the steering axis D and a vehicle axis intersecting the steering axis D and extending parallel to the vertical vehicle axis z, of the steering wheel 1 encloses with the different possible cutting planes of the cross section Q (for example with the planes III-III to XI-XI of FIG. 2) measured from the uppermost region 9 of the steering wheel rim 2, an angle of between 0° and 360°, which is denoted as an orientation angle of the cross section Q and, from the view of a driver, increases in the peripheral direction U of the steering wheel rim 2, i.e. clockwise. Preferably, the first angle W increases from the uppermost region 9 of the steering wheel rim 2 (the orientation angle is 0°) proportionally to the orientation angle, until it adopts its maximum value of 45° at an orientation angle of approximately 90° (just above the first region 6a of the steering wheel rim 2). From there, the first angle W decreases proportionally to the orientation angle until it is again 0° with an orientation angle of 180° (i.e. at the lowermost region 12 of the steering wheel rim 2).

The orientation of the cross-sectional contours K (values of the first angle W) of those portions of the steering wheel rim 2 which, from the view of a driver, are on the left side of the plane of symmetry of the steering wheel 1, are produced by a mirroring of the right half (from the view of a driver) of the steering wheel rim 2 on the plane of symmetry of the steering wheel 1.

FIG. 12 shows, in connection with FIGS. 13 to 17, a modification of the steering wheel 1 shown in FIG. 1, which in contrast to the steering wheel 1 shown in FIG. 1, has merely 3 spokes instead of 4 spokes, the two second spokes 5a, 5b of FIG. 1 being combined into a single third spoke 13, which extends longitudinally in a longitudinal extension direction, which extends transversely to the longitudinal extension direction of the two first spokes 4a, 4b, so that the three spokes are arranged as a whole in a T shape.

Similar to FIG. 2, the cross section Q of the steering wheel rim 2 of the steering wheel 1 is altered by an alteration of the orientation of the cross-sectional contour K of the cross section Q in the peripheral direction U of the steering wheel rim 2, both at the lowermost region 12 of the steering wheel rim 2 at which the third spoke 13 is secured to the steering wheel rim 2 and at the uppermost region 9 of the steering wheel rim 2 the longitudinal axis L of the cross-sectional contour K according to FIG. 17 and/or FIG. 13 enclosing a first angle W with the steering axis D, which is preferably 0°, i.e. the longitudinal axis L extends in this case respectively parallel to the steering axis D.

Also according to FIG. 15 which shows a section along the line XV-XV of FIG. 13, the maximum value of the first angle W of preferably 45° reaches approximately half way between the lowermost region 12 and the uppermost region 9 of the steering wheel rim 2 (relative to the vertical vehicle axis z).

Between the uppermost region 9 and the first region 6a of the steering wheel rim 2 which is located half way between the lowermost region 12 and the uppermost region 9 on the steering wheel rim, the first angle W is between 0 and 45°, it preferably being 22.5° at an orientation angle of 45° of the cross section Q and/or at an orientation angle of 135° according to FIGS. 14 and/or 16. The steering wheel 1 shown in FIG. 12 is also constructed mirror symmetrically to the plane of symmetry of the steering wheel 1 which is formed by the steering axis D and a vehicle axis intersecting the steering axis D and extending parallel to the vertical vehicle axis z.

FIG. 18 shows, in connection with FIGS. 19 to 21 and FIGS. 26 to 26C, a further modification of the steering wheel 1 shown in FIGS. 1 and/or 12, in contrast to FIGS. 1 and 12, five spokes for connecting the hub body 3 to the steering wheel rim 2 being provided in total, and namely two first spokes 4a, 4b which extend according to FIG. 1 along the vehicle transverse axis y and two second spokes 5a, 5b arranged thereunder along the vertical vehicle axis z which, as with the steering wheel 1 shown in FIG. 1, depart from the hub body 3 on both sides of the hub body 3, the distance from the first spoke 4a, 4b respectively arranged above along the vertical vehicle axis z increasing in the direction of the steering wheel rim 2. A third spoke 13 connects the hub body 3 according to FIG. 12 to the lowermost region 12 of the steering wheel rim 2 of the steering wheel 1.

In the above embodiment of the steering wheel 1, the spokes 4a, 4b, 5a, 5b and 13 are not only used as a connecting member between the hub body 3 and the steering wheel rim 2 but also as a support for functional elements of the steering wheel 1. In this connection, on the two first spokes 4a, 4b which project in opposing directions from the hub body 3 and extend respectively in a longitudinal extension direction extending substantially parallel to the vehicle transverse axis y, one respective actuating lever 14a, 14b is provided which are configured to be mirror symmetrical and are pivotably mounted respectively in the longitudinal extension direction between the hub body 3 and the steering wheel rim 2 on the first spoke 4a and/or the further first spoke 4b about the longitudinal extension directions thereof. The two actuating levers 14a, 14b project respectively from the first spoke 4a and/or the further first spoke 4b in the direction of a floor of the motor vehicle, into which the steering wheel 1 is installed and respectively comprise two lever arms 15, 16 extending parallel to one another. In this connection, a first lever arm 15 facing a driver is designed and provided along the steering axis D, to be actuated per each thumb pressure along the steering axis D (pressure direction facing away from the driver), whilst a second lever arm 16 extending behind the first lever arm 15, from the view of a driver, which extends parallel to the first lever arm 15, is configured to be actuated by means of the first phalanx of the remaining fingers of one hand of a driver along the steering axis D in the direction of the driver. Such actuating levers 14a, 14b are suitable, in particular, for switching processes during driving.

Furthermore, one respective rotary selector switch 17a, 17b is integrated into the two second spokes 5a, 5b which are rotatably mounted about the respective longitudinal extension direction of the second spokes 5a, 5b into which they are integrated. The two rotary selector switches 17a, 17b therefore comprise one respective actuating surface 18a, 18b surrounding the respective rotational axis, via which the rotary selector switches 17a, 17b may be manually actuated, for example by rotating the rotary selector switches 17a, 17b by means of the tip of the thumb of a driver, the actuating surfaces 18 being at a distance from the steering wheel rim 2 along the second spokes 5a, 5b such that an actuation of the actuating surfaces 18 is possible, without the hands 10 of the driver having to be removed from the steering wheel rim 2. The rotary selector switches 17a, 17b are preferably recessed in the second spokes 5a, 5b such that they do not project therefrom transversely to the longitudinal extension directions of the second spokes 5a, 5b. As a result, projections which might cause injury and hinder the handling of the steering wheel 1 are advantageously avoided. The two rotary selector switches 17a, 17b may be, with regard to their function, variably positioned and may, for example, be used for operating a navigation system of a motor vehicle or for activating, deactivating and controlling other components of motor vehicle equipment.

Whilst both the first and the second spokes 4a, 4b, 5a and 5b at respectively one region adjacent to the hub body 3, preferably have a circular cross section, perpendicular to the respective longitudinal extension direction of the spokes considered, the first spokes 4a and/or 4b, in the first regions 6a, 6b adjacent to the steering wheel rim 2, which oppose one another along the vehicle transverse axis y, have respectively a cross section Q′ oriented perpendicularly to the longitudinal extension directions of the first spoke 4a, 4b, with an oval cross-sectional contour K′, of which the longitudinal axis L′ forms a second angle W′ of preferably 22.5° with an axis D′ extending parallel to the steering axis D. As a result, the longitudinal axes L′ of the cross-sectional contours K′ of the first spokes 4a, 4b at the first regions 6a, 6b of the steering wheel rim 2, at which the first spokes 4a, 4b merge with the steering wheel rim 2, has an inclination relative to the steering axis D which allows a driver to rest the thumbs 7 comfortably on the first spokes 4a, 4b.

In contrast, the second spokes 5a, 5b comprise, in the respective second regions 6c, 6d adjacent to the steering wheel rim 2, at which the second spokes 5a, 5b run into the steering wheel rim 2, cross sections Q″ oriented perpendicularly to the longitudinal extension direction of the second spokes 5a, 5b, with respective cross-sectional contours K″ of elongate configuration, which respectively have a longitudinal axis L″, which encloses a third angle W″ of preferably 45° with an axis D′ extending parallel to the steering axis D. This also allows a driver to rest the thumbs 7 comfortably on the second spokes 5a, 5b of the steering wheel 1, the driver additionally being allowed a comfortable operation of the rotary selector switches 17a, 17b integrated in the second spokes 5a, 5b, by means of the thumbs 7, where said thumbs carry out an ergonomically advantageous downwards movement from their resting position towards the driver, for turning the rotary selector switches 17a, 17b.

According to FIGS. 26 to 26C the third spoke 13 of a steering wheel 1 of the type shown in FIG. 12 and/or FIG. 18, is used as a support of a storage means 19 which may be releasably secured to the third spoke 13, which, for example, may be configured as a USB memory stick. When secured to the third spoke 13, the storage means 19 has a functional interface 20 facing a driver, via which the storage means 19 may be operated. Preferably, the storage means 19 is used for storing personal data, which represent the parameters of comfort and safety devices of a motor vehicle. Furthermore, components of motor vehicle equipment may be activated, deactivated and controlled via the storage means 19.

When secured to the third spoke 13, the storage means 19 is connected via an interface (USB or other comparable interface) to the steering wheel 1 and may exchange information with components of motor vehicle equipment and/or control said components.

The interface is located in a holder 21 which may be pivoted out of the third spoke 13. Said holder comprises a recess for preferably positively receiving an end region of the storage means 19, with an insertion opening which has an insertion direction in which the end region of the storage means 19 is fitted into the recess of the holder 21, in order to place the storage means 19 in contact with the interface. After successful contact, the holder 21 together with the storage means 19 is pivoted back in the direction of the third spoke 13. The holder 21 and the storage means 19 located in the holder 21, are now embedded in the third spoke 13.

FIG. 22 shows, in connection with FIG. 23 to FIG. 25, a steering wheel 1 of the type known from FIG. 12, which provides removable portions A of the steering wheel rim 2, which extend according to FIG. 22 in the peripheral direction U of the steering wheel rim 2 and, namely, respectively projects from a first region 6a of the steering wheel rim 2 at which the first spokes 4a, 4b merge with the steering wheel rim 2, to the lowermost region 12 of the steering wheel rim 2, from which the third spoke 13 projects in the direction of the hub body 3. Such releasable portions A may be formed by respectively one first and one second shell element 22, 23, which may be secured to a steering wheel rim structure 24 as a base body of the steering wheel rim 2. The two shell elements 22, 23 may, for example, be secured by means of latching connections on the steering wheel rim structure 24, and respectively comprise a flat face with a recess for receiving a portion of the steering wheel rim structure 24, when fastened to the steering wheel rim structure 24, the two flat faces of the shell elements 22, 23 resting on one another, so that the portion of the steering wheel rim structure 24, along which the shell elements 22, 23 extend when fastened to the steering wheel rim structure 24, is enclosed by the two shell elements 22, 23.

Furthermore, such portions A of a steering wheel rim 2 may be mounted on the steering wheel rim structure 24 such that the first angle W which the longitudinal axis L of the cross-sectional contour K of a cross section Q of the portion A oriented perpendicularly to the peripheral direction U of the steering wheel rim 2 forms with the steering axis D, may be variably adjusted, i.e. the portion A is rotatably configured in a rotational direction S surrounding the cross-sectional contour K, the portion A being able to be adjusted to and fro at least between two positions, i.e. first angles W. To this end, in the case of a non-flexible material of the adjustable portion A, the curvature of the portion A should not emerge too far in the peripheral direction U. Possibly, flexible connecting members may connect individual shorter portions A of the aforementioned type to one another in the peripheral direction U to form a correspondingly longer adjustable portion A of the steering wheel rim 2. Alternatively, a plurality of portions A of the steering wheel rim 2 may, naturally, be adjusted independently of one another. Naturally, removable and/or adjustable portions A of a steering wheel rim 2 may also be provided on the steering wheels 1 of the type disclosed in FIGS. 1 and 18.

What is claimed is:

1. A steering wheel for a motor vehicle which may be rotatably mounted on the motor vehicle about a steering axis, with a steering wheel rim for actuating the steering wheel which extends in a peripheral direction surrounding the steering axis, and has a cross section altering in the peripheral direction, characterized in that for altering the cross section at least along a part of the steering wheel rim, the spatial orientation of a predetermined cross-sectional contour varies in the peripheral direction (U) relative to the steering axis (D).

2. The steering wheel as claimed in claim 1, characterized in that the spatial orientation of the cross-sectional contours only varies along one part of the steering wheel rim.

3. The steering wheel as claimed in claim 1, characterized in that the spatial orientation of the cross-sectional contour varies along the steering wheel rim excluding such regions of the steering wheel rime at which spokes of the steering wheel run into the steering wheel rim.

4. The steering wheel as claimed in claim 1, characterized in that the spatial orientation of the cross-sectional contour varies along the entire steering wheel rim.

5. The steering wheel as claimed in claim 1, characterized in that the orientation of the cross-sectional contour continuously varies in the peripheral direction (U) of the steering wheel rim.

6. The steering wheel as claimed in claim 1, characterized in that the spatial orientation of the cross-sectional contour varies when the cross-sectional contour is uniform in the peripheral direction (U) of the steering wheel rim.

7. The steering wheel as claimed in claim 1, characterized in that the spatial orientation of the cross-sectional contour varies when the surface of the cross section is uniform in the peripheral direction (U) of the steering wheel rim.

8. The steering wheel as claimed in o claim 1, characterized in that the cross-sectional contour is configured as an elongate, enclosed contour with a longitudinal axis (L).

9. The steering wheel as claimed in claim 8, characterized in that the longitudinal axis (L) of the cross-sectional contour in a straight-ahead driving position of the steering wheel rim—relative to when the steering wheel is installed in a motor vehicle—encloses a first angle with the steering axis (D) which, depending on the position of the cross-sectional contour along the steering wheel rim, increases from an uppermost region of the steering wheel rim, along the steering wheel rim, until it reaches a maximum value—approximately half way between the uppermost and a lowermost region of the steering wheel rim.

10. The steering wheel as claimed in claim 9, characterized in that the first angle decreases from its maximum value which it adopts approximately half way between the uppermost and the lowermost region of the steering wheel rim, in the peripheral direction (U) towards the lowermost region of the steering wheel rim.

11. The steering wheel as claimed in claim 9, characterized in that the steering wheel rim at the uppermost region of the steering wheel rim has a cross-sectional contour, of which the longitudinal axis (L) forms a first angle of 0° with the steering axis (D).

12. The steering wheel as claimed in claim 9, characterized in that the steering wheel rim has a cross-sectional contours at the lowermost region of the steering wheel rim, of which the longitudinal axis (L) forms a first angle of 0° with the steering axis (D).

13. The steering wheel as claimed in claim 9, characterized in that the steering wheel rim half way between the uppermost and lowermost region, has a cross-sectional contour of which the longitudinal axis (L) forms a first angle of 45° with the steering axis (D).

14. The steering wheel as claimed in claim 1, characterized in that the steering wheel rim surrounds the steering axis (D) in a manner which is intrinsically closed.

15. The steering wheel as claimed in claim 1, characterized in that an outer contour of the steering wheel rim is at a distance from the steering axis in a direction perpendicular to the steering axis (D), which—relative to a straight-ahead driving position of the steering wheel—is greater above the steering axis (D) than below the steering axis (D).

16. The steering wheel as claimed in claim 1, characterized in that a distance between an outer contour of the steering wheel rim and the steering axis (D) is substantially uniform in a direction perpendicular to the steering axis (D) in a region which, from the view of a driver, extends along the steering wheel rim clockwise from an 8 o'clock position to a 4 o'clock position.

17. The steering wheel as claimed in claim 16, characterized in that the region on both sides of the steering axis (D) merges with a flattened portion of the steering wheel rim extending parallel to the vehicle transverse axis (y), the outer contour of the steering wheel rim being at a smaller distance from the steering axis (D) along the flattened portion than along the region.

18. The steering wheel as claimed in claim 1, characterized in that the steering wheel rim has a portion extending in the peripheral direction (U) with a cross section oriented perpendicularly to the peripheral direction (U), which has an elongate, enclosed cross-sectional contour with a longitudinal axis (L), which encloses a first angle with the steering axis (D).

19. The steering wheel as claimed in claim 18, characterized in that the portion is configured to be adjustable, such that the first angle is variable.

20. The steering wheel as claimed in claim 18, characterized in that the portion of the steering wheel rim is configured to be manually adjustable for adjusting the first angle.

21. The steering wheel as claimed in claim 19, characterized in that the portion of the steering wheel rim is configured to be manually adjustable at least between a first and a second position, with respectively different values of the first angle.

22. The steering wheel as claimed in claim 21, characterized in that the portion is configured to be releasably engaged in the two positions respectively.

23. The steering wheel as claimed in claim 19, characterized in that the portions is designed and provided to adjust the first angle electrically and/or to be moved hydraulically.

24. The steering wheel as claimed in claim 19, characterized in that the adjustable portion of the steering wheel rim is releasably secured to the steering wheel.

25. The steering wheel as claimed in claim 1, characterized in that the steering wheel rim has at least one steering wheel rim structure as a base body of the steering wheel rime and a steering wheel cover encompassing the steering wheel rim structure.

26. The steering wheel as claimed in claim 25, characterized in that the steering wheel cover is at least partially releasably secured to the steering wheel rim structure.

27. The steering wheel as claimed in claim 1, characterized in that a hub body is provided via which the steering wheel may be rotatably mounted about the steering axis (D) on a motor vehicle.

28. The steering wheel as claimed in claim 27, characterized in that the steering wheel rim has at least one first spoke connecting the steering wheel rim to the hub body.

29. The steering wheel as claimed in claim 28, characterized in that the first spoke extends longitudinally in a longitudinal extension direction.

30. The steering wheel as claimed in claim 29, characterized in that the longitudinal extension direction of the first spoke extends in a straight-ahead driving position of the steering wheel—relative to when the steering wheel is installed in a motor vehicle—along the vehicle transverse axis (y).

31. The steering wheel as claimed in claim 29, characterized in that the first spoke, in a region adjacent to the hub body, has a cross section with a circular cross-sectional contour oriented perpendicularly to the longitudinal extension direction of the first spoke.

32. The steering wheel as claimed in claim 28, characterized in that on the first spoke an actuating lever is arranged for activating and/or controlling a component of a motor vehicle.

33. The steering wheel as claimed in claim 32, characterized in that the actuating lever projects from the first spoke transversely to the longitudinal extension direction of the first spoke and is pivotably mounted on the first spoke for activating and/or controlling a component of a motor vehicle about this longitudinal extension direction.

34. The steering wheel as claimed in claim 29, characterized in that the first spoke in a first region adjacent to the steering wheel rim has a cross section oriented perpendicularly to the longitudinal extension direction of the first spoke, with an elongate, enclosed cross-sectional contour which has a longitudinal axis (L′) which—relative to when the steering wheel is installed in a motor vehicle—forms a second angle with an axis (D′) extending parallel to the steering axis (D).

35. The steering wheel as claimed in claim 34, characterized in that the second angle is less than 45°, in particular 22.5°.

36. The steering wheel as claimed in claim 29, characterized in that the first spoke—relative to when the steering wheel is installed in a motor vehicle—in a straight-ahead driving position of the steering wheel has a support surface facing the roof of the motor vehicle for a thumbs of a driver, with a depression adapted to the shape of the thumb.

37. The steering wheel as claimed in claim 28, characterized in that the steering wheel has a further second spoke for connecting the steering wheel rime to the hub body.

38. The steering wheel as claimed in claim 37, characterized in that the second spoke extends longitudinally in a longitudinal extension direction.

39. The steering wheel as claimed in claim 38, characterized in that the second spoke in a region adjacent to the hub body has a cross section with a circular cross-sectional contour oriented perpendicularly to the longitudinal extension direction of the second spoke.

40. The steering wheel as claimed in claim 38, characterized in that for activating and controlling safety and/or comfort functions of motor vehicle equipment a rotary selector switch is integrated in the second spoke.

41. The steering wheel as claimed in claim 40, characterized in that the rotary selector switch has an actuating surface surrounding its rotational axis, for actuating the rotary selector switch.

42. The steering wheel as claimed in claim 41, characterized in that the actuating surface merges steplessly with an outer surface of the second spoke in the longitudinal extension direction of the second spoke.

43. The steering wheel as claimed in claim 38, characterized in that the second spoke, in a second region adjacent to the steering wheel rim, has a cross section oriented perpendicularly to the longitudinal extension direction of the second spoke, with an elongate, enclosed cross-sectional contour which has a longitudinal axis (L″)—relative to when the steering wheel is installed in a motor vehicle—which encloses a third angle with an axis (D′) extending parallel to the steering axis (D).

44. The steering wheel as claimed in claim 43, characterized in that the third angle is an acute angle which is, in particular, 45°.

45. The steering wheel as claimed in claim 37, characterized in that the first spoke—relative to when the steering wheel is installed in a motor vehicle—in a straight-ahead driving position of the steering wheel along the vertical vehicle axis (z), is arranged above the second spoke.

46. The steering wheel as claimed in claim 37 characterized in that the first and the second spoke diverge from one another away from the hub body in the direction of the steering wheel rim.

47. The steering wheel as claimed in claim 37 characterized in that the steering wheel has a third spoke for connecting the hub body to the steering wheel rim.

48. The steering wheel as claimed in claim 47, characterized in that the third spoke—relative to when the steering wheel is installed in a motor vehicle—with a straight-ahead driving position of the steering wheel, extends in a plane which is stretched through the steering axis (D) and a vehicle axis intersecting the steering axis (D) and extending parallel to the vertical vehicle axis (z).

49. The steering wheel as claimed in claim 1, characterized in that the steering wheel has a storage means for storing motor vehicle-related data and passenger-related data.

50. The steering wheel as claimed in claim 49, characterized in that the storage means may be releasably secured to the steering wheel.

51. The steering wheel as claimed in claim 49, characterized in that the storage means may be secured to an upper face of the steering wheel rim facing a driver.

52. The steering wheel as claimed in claim 49, characterized in that a hub body is connected to the steering wheel rim by a spoke, and the spoke is configured such that the storage means may be releasably secured to the spoke.

53. The steering wheel as claimed in claim 49, characterized in that the storage means has a functional interface which, when the storage means is secured to the steering wheel, faces a driver.

54. The steering wheel as claimed in claim 53, characterized in that the functional interface is provided and designed to detect biometric features of a driver.
